(19) United States
(12) Patent Application Publication
(10) Pub. No.: US 2005/0282492 A1
(43) Pub. Date: Dec. 22, 2005

(54) Wireless phone concept

(76) Inventor: George A. Lopez, Tucson, AZ (US)

Correspondence Address: Lawrence R. Oremland, P.C., Suite C-214, 5055 E. Broadway Boulevard, Tucson, AZ, 85711, US

(21) Appl. No.: 11/113,668

(22) Filed: Apr. 25, 2005

Related U.S. Application Data
(60) Provisional application No. 60/565,427, filed on Apr. 26, 2004.

(51) Int. Cl. H04B 7/185; H04Q 7/20

(52) U.S. Cl. 455/12.1

(57) ABSTRACT

A wireless base phone that connects to a wireless service provider and to associated satellite (auxiliary) phones is provided. The wireless base phone negates having to have the traditional phone at home or in a business that connects to traditional outside wired telecommunications network (PSTN). The consumer can save on not having to pay for this traditional wired network service. Instead, a consumer can purchase a wireless family plan or similar plan from a wireless service provider that allows for the purchase of several wireless phones at a low rate. One or more of the wireless phones is set up similar to traditional desktop, counter top, wall mounted, or similar type phones. This allows the consumer to place a wireless base phone or phones at their residence, business, or any other desired location. This wireless base phone can transmit to other wireless phones through the wireless service providers network. The base phone can also transmit and receive to/from nearby satellite (auxiliary) phones that are connected to it either with the buildings own internal wired network or though its own wireless transmit and receive capabilities.

### RELATED APPLICATION/CLAIM OF PRIORITY

This application is related to and claims priority from provisional application Ser. No. 60/565,427, filed Apr. 26, 2004, and entitled Wireless Base Phone, which provisional application is incorporated by reference herein.

### BACKGROUND AND SUMMARY OF THE INVENTION

The present invention relates to a modified cellular/wireless phone concept. A wireless base phone is designed to be a replacement for the traditional home or business phone of a type that is tied into a wired telecommunications network. The base phone of the present invention will receive and transmit wireless radio frequency signals from a wireless provider, such as Qwest, ALLTEL, AT&T, or other similar providers. The base phone can then be set up to transmit and receive to other satellite (auxiliary) cordless, and corded phones associated/linked with it through full duplex radio frequency or through the building's own wired network. This will allow consumers to eliminate the use and cost of the traditional telephone tied into the wired telecommunications network. The base phone can also (due to the new phone number portability legislation, which requires phone carriers to allow for the transition of telephone numbers from standard wired telecommunications network to wireless phones, which take the homeowners' or business's original phone number) enable a consumer to transfer a prior telephone number to the base phone. The base phone can also be a part of a wireless provider's family plan as one of the family plan phones; thereby, saving more money by eliminating the traditional wired phone when a customer has both wireless and traditional wired telecommunication plans.

Many people have a phone system for a house or business tied into the traditional wired telecommunications system. Some also purchase wireless phones from wireless providers thereby, incurring additional costs. To save money some of these individuals are disconnecting from the wired network and just using the wireless network. This has the disadvantage of leaving the home or business without the traditional base phone that always stays at the home or business and that everyone knows its phone number. Some individuals' even purchase an additional personal cell phone to leave at home but these are small, portable, and easily misplaced. In applicant's experience, people like having a larger phone or phones that stay in one place so they can always know where at least one phone is. Additional satellite (auxiliary) phones can be linked to the base phone, through cordless or wired connection, and placed around the house or building.

Many wireless providers sell family plans where the consumer purchases the first wireless personal phone for a base price and then additional wireless personal phones for a lower cost per phone. These additional phones can be distributed to family members. Sometimes an additional wireless phone is purchased and left at the home or business to serve as a replacement for the traditional wired phone that is associated with that location. This additional cellular phone can be lost or misplaced easily.

The present invention accomplishes the following

1. A consumer can purchase the first wireless base phone that is similar to a traditional wired phone except for not being connected to the wired telecommunications network or otherwise known as the Public Switched Telephone Network (PSTN).

2. Since it is similar in size to the traditional phone the wireless base phone won't be as easily misplaced or lost.

3. The base phone receives and transmits full duplex radio frequency (or if so designed spread spectrum) signals to and from the wireless provider network such as AT&T, Qwest, Nextel, ALLTEL, to name a few.

4. If the base phone was purchased in a wireless provider family plan, then additional personal wireless phones can be purchased and distributed to other individuals.

5. The base phone is set up to transmit and receive full duplex (if so designed, spread spectrum capability) radio frequency (different frequency from those listed above) signals to and from nearby corded or cordless satellite (auxiliary) phones that are associated with it. GSM/CTS (Global System for Mobile Communications/Cordless Phone Telephony), DCS 1800 (Digital Cordless Standard), DECT (Digital European Cordless Phone Technology), or other newer or similar cordless technologies can be used for this aspect of the Wireless Base Phone to satellite (auxiliary) phone operation. This is similar to present wired systems in use except for the base phone not being tied into the wired telecommunications system (PSTN). The base phone is in circuit communication with the satellite (auxiliary) phones, e.g. by wired connections or by antenna-to-antenna connections.

6. The new phone number portability legislation will allow consumers to transfer their prior telephone number to the new base phone. This will relieve the consumer from the need of having to inform customers, friends, clients, and family of a phone number change.

7. The present invention allows the consumer to connect to a wireless telecommunications network, thereby allowing the consumer to not have to pay for access to a wired telecommunications network as well as access to a wireless telecommunications network.

Definitions: In this application, reference to a “base phone” means the telecommunication device (handset and/or phone base) that sets up a connection with the wireless provider. It receives transmissions from and sends transmissions to the wireless provider. The base phone also transmits the transmissions from the wireless provider to the satellite (auxiliary) phones and receives transmissions from the satellite (auxiliary) phones and transmits them to the wireless provider. Reference to a “Satellite or “auxiliary” phone means the telecommunication device (auxiliary handset and/or phone base) that receives and/or transmits and receives transmissions from/to the base phone.

Further features of the present invention will become apparent from the following detailed description and the accompanying drawings.

### BRIEF DESCRIPTION OF THE DRAWINGS

FIG. 1 is a schematic illustration of the components of a wireless base phone, according to the present invention;

FIG. 2 is a schematic illustration, depicting how the wireless base phone of this present invention transmits and receives to and from the wireless service provider and satellite (auxiliary) phones.

FIG. 3 is a block diagram schematically illustrating the frequencies as they pass through the Wireless Base-Phone from the wireless service provider to the satellite (auxiliary) phones and from the satellite (auxiliary) phones through the Wireless Base-phone to the wireless service provider.

FIG. 4 is a block diagram depicting how the Wireless Base-Phone can be used in conjunction with Internet digital Voice Over Internet Protocol (VoIP) technology.

### DETAILED DESCRIPTION

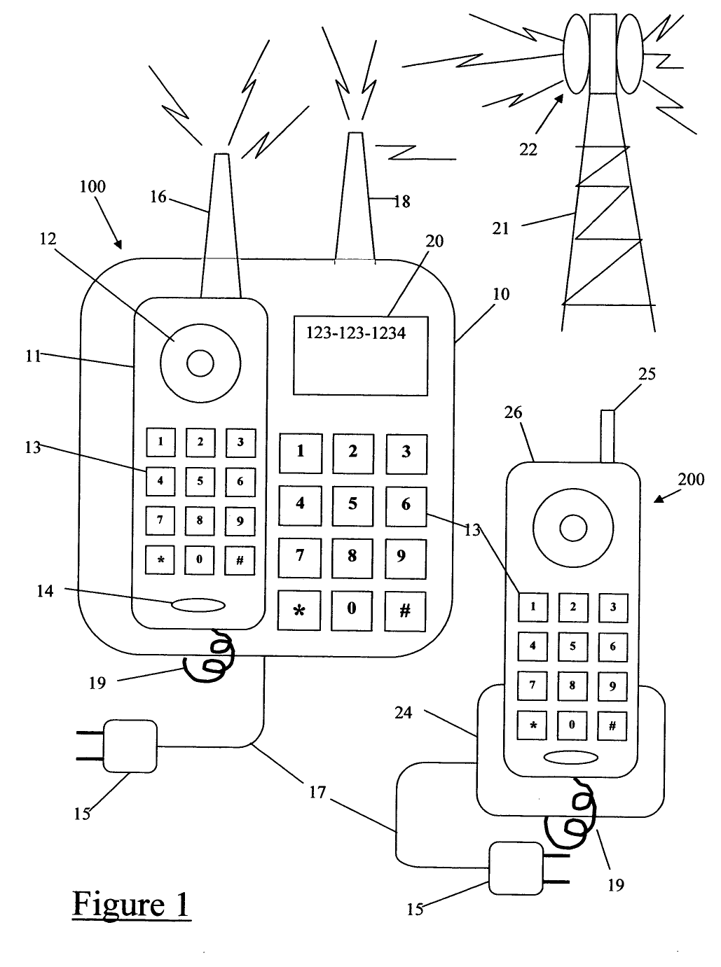

FIG. 1 shows a base phone 100 that preferably comprises a telephone base 10 and a handset 11 supported on the phone base 10. The handset 11 can be cordless or the telephone base 10 can be equipped with a cord 19 that links the handset 11 with the telephone base 10. The handset 11 has a conventional audio speaker ear-piece 12, a typical keypad 13 for dialing telephone numbers (or can have a rotary dial mechanism, which is not shown) or text type messaging, and a conventional microphone 14 that receives audio input. The handset 11 also has an antenna 16, if it is a cordless phone. The phone base 10 has a set of molded indentations (not shown) or a single indentation to rest the handset 11 in. If the handset 11 is a cordless phone, the handset 11 is battery powered and is recharged by the battery charging system (not shown) built into the phone base 10. The phone base 10 has a conventional electrical power cord 17 and a conventional power cord/wall outlet plug 15. The base phone has an antenna 18 to transmit and receive full duplex radio frequencies (if so designed, spread spectrum capability) to the wireless service provider and to the satellite (auxiliary) phones 200. This means the base phone 100 will be capable of receiving and transmitting in four frequencies. One outbound frequency to the wireless service provider paired with one inbound frequency from the wireless service provider. Another frequency will be used to send to the satellite (auxiliary) phones 200 and another frequency will be used to receive transmissions from the satellite (auxiliary) phones 200.

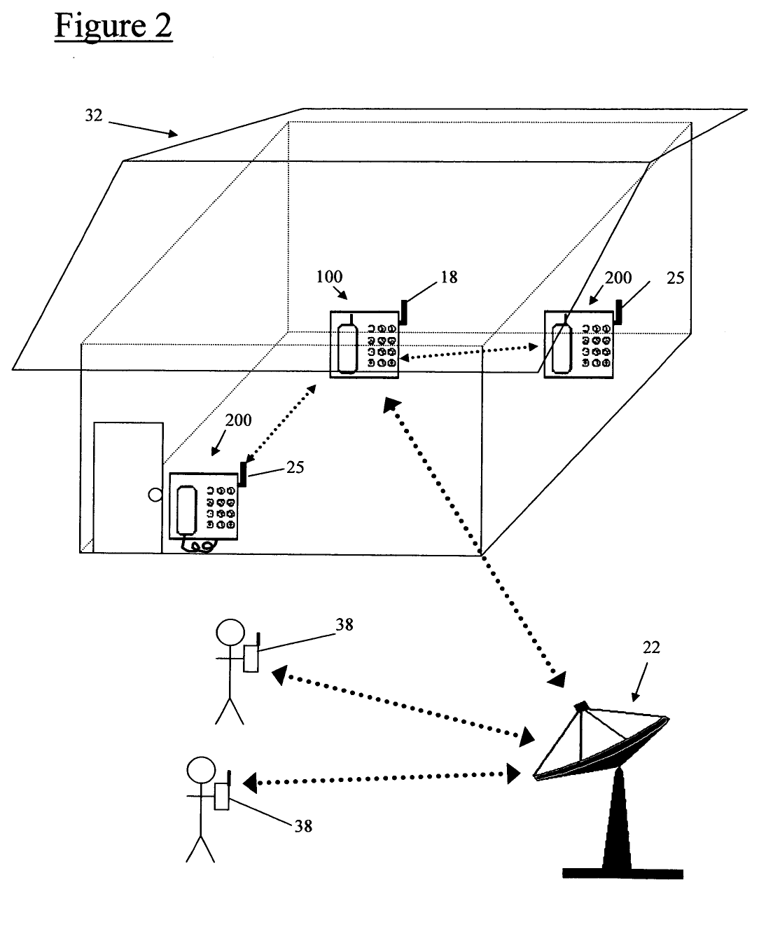

The wireless base phone 100 is configured to look and feel like current phones that currently are in use and tied into the wired telecommunications network (PSTN). The handset 11 is larger than a personal cell phone 38 (shown in FIG. 2) and therefore easier to hold and cradle in a person's hand. The large phone base 10 makes it easy to set the handset 11 in a central location and find it easily whereas a personal cell phone 38 can be easily lost. The large Wireless Base-Phone 100 can be equipped to send radio frequency transmissions to satellite (auxiliary) phones 200 that can be set in convenient locations around a building, home, or business thereby negating having to have an internal telephone wired system in the building or home. This will help to reduce the cost of building homes, or structures or having to run wires throughout the structure if more phones are needed.

A telecommunications tower 21 with conventional antennae 22 transmits and receives wireless service provider telecommunication signals to and from the wireless base phone 100 and other personal wireless phones 38 (see FIG. 2).

The base phone 100 can also have other phones linked to it similar to current models on the market that a consumer can purchase with multiple linked phones. For the purposes of this patent application these linked phones are called satellite (auxiliary) phones 200. Different configurations can be used and are described, but not limited to those below:
Each of the satellite (auxiliary) phones 200 comprises a satellite (auxiliary) phone handset 26 that can also have an optional cord 19 that links the handset 26 to a base 24. The antenna 25 can be mounted to the handset 26 or to the base 24. The receiver/transmitter (not shown) can be built into the base 24 or the handset 26.
A satellite (auxiliary) phone 200 can be cordless. In this case the antenna 25 is mounted to the handset 26, which also contains the receiver transmitter (not shown). The base 24 acts as a recharging unit for the handset 26.
In cases where satellite (auxiliary) phone 200 has to be set long distances from the wireless base phone 100, the base 24 can have a larger transmitter/receiver (not shown) built into it. This satellite (auxiliary) phone 200 can have a cord 19 or be cordless. Following is a description of how this corded and cordless system is set up.
1. In the case where the satellite (auxiliary) phone 200 is equipped with a cord 19 attaching base 24 to the handset 26. The antenna 25 can be attached to the base 24 or to the handset 26.
2. In the case where the satellite (auxiliary) phone 200 is cordless, the base 24 will have an antenna (not shown) and the handset 26 will also have an antenna 25. The base 24 will be equipped to transmit in two sets of full duplex (if so designed, spread spectrum capability) radio frequencies. One frequency will be used to transmit to the wireless base phone 100 and the second frequency will be used to receive from the wireless base phone 100. A third frequency will be used to transmit to the handset 26 and the fourth frequency will be used to receive from the handset 26.

FIG. 2 is a schematic view showing how the communication device interacts with the various components. A wireless service provider transmitter receiver antenna 22 transmits and receives telecommunication signals. A structure 32 is typically where a wireless base phone 100 and wireless satellite phones 200 will be situated. A conventional wireless personal phone 38 transmits and receives telecommunications signals to the wireless service provider transmitter receiver antenna 22.

The wireless base phone 100 uses two sets of full duplex frequencies, meaning a minimum of four radio frequencies is required to operate the phone. The wireless base phone 100 will use one frequency to send to the wireless service provider antenna 22 and use a second frequency to receive from the wireless service provider. A third radio frequency will be used to send to the satellite (auxiliary) phones 200 while using a fourth frequency to receive from the satellite (auxiliary) phones 200. The base phone 100 can also be equipped with a RJ-11 or similar type connector to send signals that have been converted from the radio frequency input from the wireless service provider to the satellite (auxiliary) phones 200 through the building's own internal wired network.

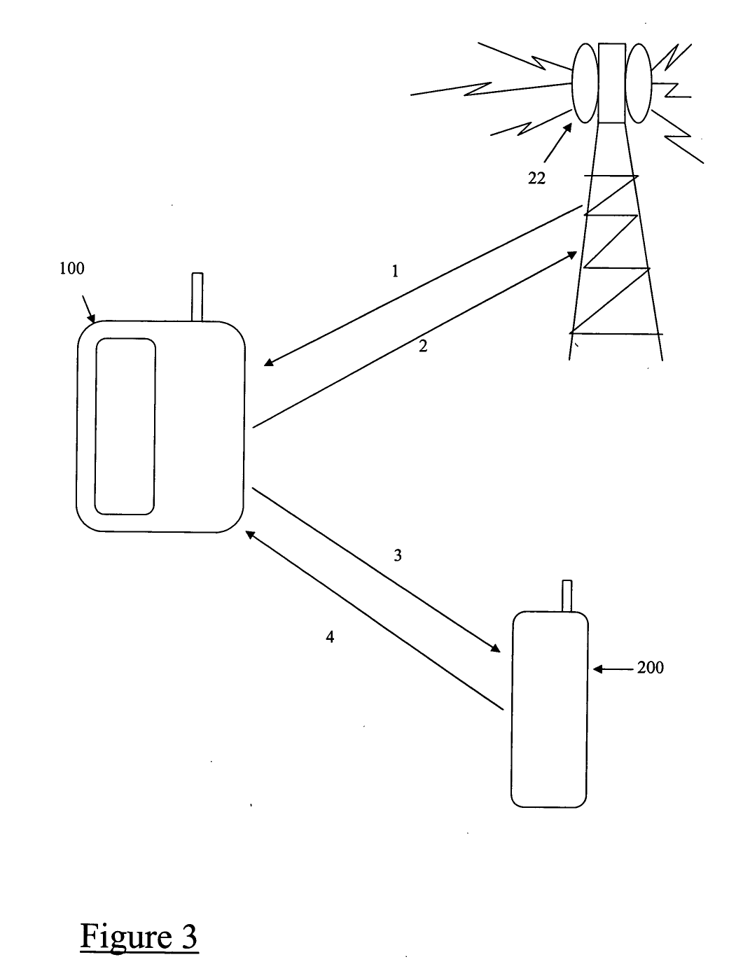

FIG. 3 elaborates on how the four frequencies are utilized by the Wireless Base-Phone 100 to achieve its applied functions. (Artisans skilled in the manufacture of cell phones and standard wired phones will appreciate that items in the drawing are illustrated for simplicity. Note the items are not drawn to scale in any of the figures or drawings. Well-understood and common elements that are used in the creation of a commercially feasible product are not typically depicted in order to depict a less cluttered view of different items of the Wireless Base-Phone invention.) As stated in the previous paragraph, two sets of full duplex frequencies are utilized by the Wireless Base-Phone 100, meaning a minimum of four frequencies are required. In FIG. 3, the artisan can see that frequency 1 represents the inbound transmission from the wireless service provider 22, which is received by the Wireless Base-phone 100. The frequency is converted to another frequency 3, which is utilized to transmit to the satellite (auxiliary) phones 200. The satellite (auxiliary) phones 200 transmit on frequency 4 back to the Wireless-Base Phone 100. Frequencies 3 and 4 act as one pair of the full duplex frequencies and can use similar technology as the following for transmitting and receiving: GSM/CTS (Global System for Mobile Communications/Cordless Phone Telephony), DCS 1800 (Digital Cordless Standard), DECT (Digital European Cordless Phone Technology), or other newer or similar cordless technologies can be used for this aspect of the Wireless Base Phone 100 to/from the satellite (auxiliary) phone 200 operation. The Wireless Base-Phone 100 receives the transmission (frequency 4) from the satellite (auxiliary) phone 200, which converts frequency 4 to frequency 2. Frequency 2 is then transmitted from the Wireless Base-Phone 100 to the Wireless service provider 22. In this example, frequencies 1 and 2 act as one pair of the full duplex frequencies, which utilize standard wireless service provider technologies such as: Advanced Mobile Phone System (AMPS, Analog), Frequency Division Multiple Access (FDMA), Time Division Multiple Access (TDMA), Code Division Multiple Access (CDMA) or any of its derivatives such as CDMA2000 and CDMA2000 1XEV, Global Systems for Mobile communications (GSM), Personal Communications Services (PCS), and any new or newer technologies that will be used in the future for wireless phone communication.

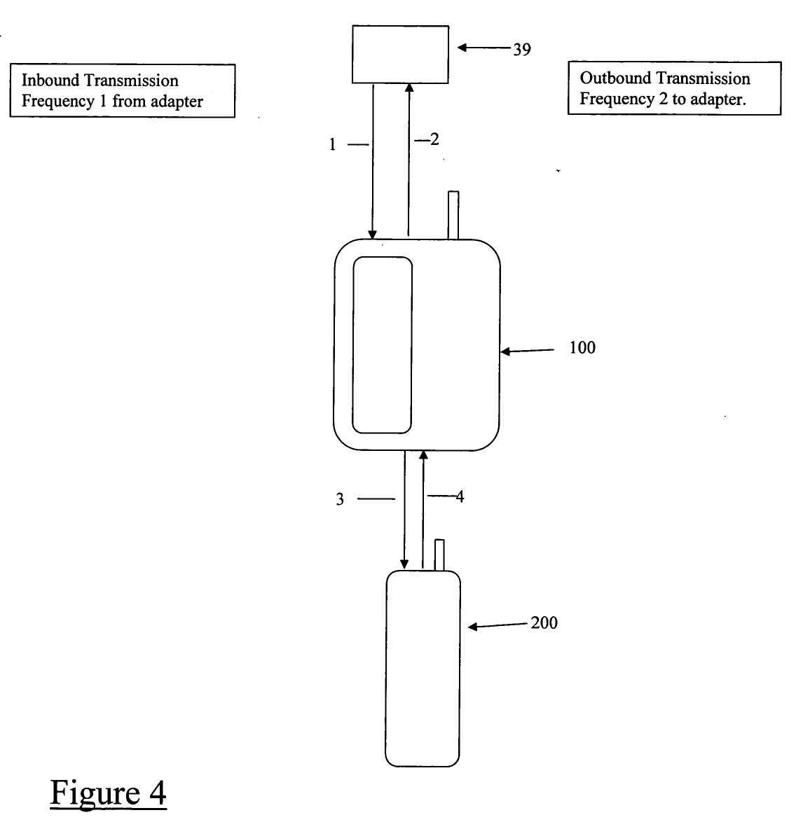

FIG. 4 depicts how the Wireless Base Phone can be utilized with Voice over Internet Protocol (VoIP) or similar technologies. In this example, a third party vendor will supply an appropriate adaptor 39 that can take information from the internet and convert it to an output transmit frequency 1. Frequency 1 is received by the Wireless Base-Phone 100 and converted to frequency 3, which is transmitted to the satellite (auxiliary) phone 200. The satellite (auxiliary) phone 200 transmits on frequency 4 back to the Wireless Base-Phone 100, which converts frequency 4 to frequency 2, which it transmitted back to the Voice over Internet Protocol (VoIP) technology adapter 39. Note, that in this scenario all the frequencies will most likely utilize but are not limited to GSM/CTS (Global System for Mobile Communications/Cordless Phone Telephony), DCS 1800 (Digital Cordless Standard), DECT (Digital European Cordless Phone Technology), or other newer or similar cordless technologies.

Description of How the Wireless Phone Base Achieves its Results

The wireless phone base 100 achieves its results by acting as a wireless receiver from a wireless service provider or as a transmitter to a wireless service provider just as any personal wireless phone in use today that individuals carry on their person does.

It also transmits and receives radio/wireless signals to nearby satellite (auxiliary) phones 200 linked to it.

FIG. 1 depicts a wireless base phone 100. The base phone is not similar to other phones in that it is not designed with an RJ-11 or similar type connector (not shown) that is used to connect the phone to the present wired telecommunications system network (PSTN). Instead the wireless base phone 100 has a built in wireless receiver/transmitter and antenna 18, similar to personal wireless phones that allow the base phone to connect to transmit and receive to and from a wireless service provider's network and to receive and transmit to the satellite (auxiliary) phones 200.

The wireless base phone 100 has a the following additional items; a hand set 11 that is either connected to the phone base 10 with a conventional cord 19 or is cordless, the handset 11 has the typical ear speaker 12 that emits audio and a microphone 14 used to pick up audio transmissions. The handset 11 also has a conventional keypad 13 or rotary dialing (not shown) for dialing telephone numbers or for entering text messaging. The handset can have many other options that are not shown here but can be found on many telephones.

The wireless base phone 100 is similar to present desktop, countertop, and wall-mounted phones. They can be placed in central locations that are easy to locate. The hand set 11 is larger than a personal wireless cell phone 38; therefore, it is easier to handle and use while the phone base 10 contains large sized features that are easy to distinguish and use. The wireless base phone 100 is more convenient since it comes with additional satellite (auxiliary) phones 200 that can be placed throughout a structure, building, or house even if a RJ-11 connector is not readily available since the wireless base phone 100 and satellite (auxiliary) phone 200 or phones communicate with full duplex (if so designed spread spectrum) radio frequency capabilities.

The wireless phone base 10 also comes with a conventional electrical power cord 17 attached to a conventional power outlet plug 15 to provide electrical input to power it and or to power a battery charger (not shown) for a cordless handset 11, if so designed. The phone base 10 has an antenna 18 and a receiver/transmitter (not shown) built into it for transmitting and receiving radio/wireless transmissions from a wireless service provider, represented here by transmitter/receiver antenna 22, and for receiving and transmitting to its, if so designed, conventional cordless handset 11 equipped with antenna 16, and for transmitting and receiving to corded or cordless satellite phones 200. The phone base 10 acts as a transfer point for radio transmissions from/to the wireless service provider and from/to the satellite phones 200. Note the phone base 10 and its satellite phones 200 are linked together similar to present conventional cordless phone packages that transmit from/to each other within the linked/associated phone system using full duplex radio frequency (if so designed, spread spectrum capability).

The satellite (auxiliary) phone 200 can come in various configurations.
1. The handset 26 can have a cord 19 that attaches it to the base 24 and can be designed with the same features as described for handset 11 as well as having additional features that many phones come with but are too many to list here for the purposes of this patent application. The receiver/transmitter (not shown) can be built into the handset 26 or base 24. The antenna (25) can be built into the handset 26 or the base 24. The satellite (auxiliary) phone 200 receiver/transmitter receives radio frequency transmissions from the wireless base phone 100 and transmits back to the wireless base phone 100. GSM/CTS (Global System for Mobile Communications/Cordless Phone Telephony), DCS 1800 (Digital Cordless Standard), DECT (Digital European Cordless Phone Technology), or other newer or similar cordless technologies can be used for this aspect of the Wireless Base Phone 100 to satellite (auxiliary) phone 200 operation.
2. The satellite (auxiliary) phone 200 can be cordless. In this case the handset 26 set has an antenna 25 and the receiver/transmitter (not shown) is built into it. The base 24 has a battery-recharging (not shown) unit built into it for the handset 26. The receiver/transmitter receives radio frequency transmissions from the wireless base phone 100 and transmits back to the wireless base phone 100. GSM/CTS (Global System for Mobile Communications/Cordless Phone Telephony), DCS 1800 (Digital Cordless Standard), DECT (Digital European Cordless Phone Technology), or other newer or similar cordless technologies can be used for this aspect of the wireless base phone 100 to satellite (auxiliary) phone 200 operation.
3. The satellite (auxiliary) phone 200 can be cordless with a receiver/transmitter (not shown), battery charger (not shown), and antenna (not shown) built into the base 24. The handset 26 will also have a receiver transmitter built into it as well as an antenna 25. The receiver/transmitter in the base 24 will communicate with both the wireless base phone 100 and the handset 26. The receiver/transmitter in the base 24 will use two sets of full duplex (if so designed, spread spectrum technology) radio frequencies. One frequency to transmit to the base phone 100 and a second frequency to receive from a base phone 100. The third frequency transmits to the handset 26 and the fourth receives from the handset 26. This configuration allows for a larger transmitter receiver to be built into the base 24 so it can be set at longer distances from the wireless base phone 100. GSM/CTS (Global System for Mobile Communications/Cordless Phone Telephony), DCS 1800 (Digital Cordless Standard), DECT (Digital European Cordless Phone Technology), or other newer or similar cordless technologies can be used for this aspect of the wireless base phone 100 to satellite (auxiliary) phone 200 operation.

FIG. 2 depicts an overall view of how the Wireless Base-Phone system works. The wireless base phone 100 has a conventional radio/wireless receiver transmitter similar to the ones used in personal wireless phones 38 that people carry with them and is used to connect to a wireless service provider system. The base phone 100 also has a conventional radio/wireless receiver transmitter that is used to transmit and receive from/to satellite (auxiliary) phones 200 that are linked to it similar to conventional phone packages that can be currently purchased.

For example, a wireless service provider can package the wireless base phone 100 in a family plan as the first phone. This wireless base phone 100 can have the home or business's original phone number transferred to it due to new phone number portability legislation. The wireless-phone service provider can then sell additional personal wireless phones 38 under family plans. The wireless base phone 100 can also be sold with additional satellite (auxiliary) phones 200 that the consumer can put throughout the house, business, building or structure.

Alternative Methods of Making the Wireless Base Phone

There are alternative methods in which the wireless base phone may be set up, as discussed below.
The wireless base phone can have an RJ-11 or similar connector so the consumer can choose whether to use it with the standard wired telecommunications network or with a wireless provider.
The wireless base phone can be set up with an RJ-11 or similar type connector that will send out and receive telecommunications signals to other associated/linked phones within the building's wired network. Note the buildings wired network is not connected to the outside wired telecommunications network (PSTN). The base phone will receive transmitted signals from the wireless provider and then send the signals through the building's internal wired network. Linked or associated phones can then send telecommunication signals back to the base phone through the building's internal wired network, which will then transmit the telecommunications signals to the wireless provider.
The wireless base phone can be devised in such a way that it can be mounted onto a wall and does not necessarily have to sit on a horizontal or nearly horizontal surface.
The wireless base phone can be made using any of a number of industry standard wireless technologies such as, Advanced Mobile Phone System (AMPS, Analog), Frequency Division Multiple Access (FDMA), Time Division Multiple Access (TDMA), Code Division Multiple Access (CDMA) or any of its derivatives such as CDMA2000 and CDMA2000 1XEV, Global Systems for Mobile communications (GSM), Personal Communications Services (PCS), and any new technologies that will be used in the future for wireless phone communication.
The phones can be made using dual band, tri-band, dual mode, or any combination of the mentioned methods can be used.
The phones can be set up as a Wi-Fi, WiMax (802.16a), or Ultra Wide band receiver transmitter or can use Voice Over Internet Protocol (VoIP) technology to send and receive phone calls over the Internet. These phones can incorporate 2G (Second Generation), 2.5G (Second and half Generation), 3G (Third Generation), 4G (Forth Generation) or newer standards and 802.11 a, b, g, super g, or similar or newer technology standards. See FIG. 4 for an example of how the Wireless Base-Phone can be used in conjunction with the Voice over Internet Protocol (VoIP) technology. GPS (Global Positioning System) can also be incorporated into the phone as well.

In addition, by eliminating the wired communications phone cost the consumer will save money. Following is an example of the potential savings. Please note this cost savings will vary between plans and options. Note purchase of phone hardware is not included in these estimates.

### EXAMPLE 1

Assumptions—Family With Both Home Wired Phone Service and Wireless Service Plans.
Family of four
Local home service through PSTN, which includes, $50.00 local phone service and $16.78 for long distance service provider, therefore, $50.00+$16.78=$66.78 per month excluding taxes
Purchase of wireless family calling plan of $39.99 for the first phone and $9.99 for additional phones per month.
Two wireless phones purchased; therefore, $39.99+$9.99=$49.98 monthly cost excluding taxes
Total cost for both phone systems is $49.98+$66.78=$116.76 per month excluding taxes

### EXAMPLE 2

Assumptions—Family of Four With Wireless Base Phone Family Plan.
Purchase the wireless base phone that stays at home for $39.99 monthly service cost and has previous wired phone number transferred to it due to phone number portability legislation.
Purchase second portable wireless phone for $9.99 per month service charge for Dad.
Purchase third portable wireless phone for $9.99 per month service charge for Mom.
Total costs excluding taxes $39.99+$9.99+$9.99=$59.97 service charge per month

### EXAMPLE 3

Savings Between Both Plans

Example 1−Example 2=$116.76−$59.97=$56.79 per month service charge excluding taxes.

The present invention allows the consumer to connect to a wireless telecommunications network, thereby allowing the consumer to not have to pay for access to a wired telecommunications network (PSTN) as well as access to a wireless telecommunications network.

Thus, the foregoing detailed description provides a wireless base phone that communicates with a service provider, and auxiliary (satellite) phone(s) that communicate with the base phone in a manner that enables effective, efficient and cost efficient phone service to a family and/or entity. With the foregoing disclosure in mind, various ways to provide such a phone system will be apparent to those in the art.

LIST OF REFERENCE NUMBERS

100 Wireless Base Phone
10. Wireless phone base
11. Phone hand set, either corded or cordless
12. Audio Speaker for phone
13. Keypad
14. Microphone
15. Plug with power cord
16. Hand Set Antenna
17. Electrical power cord
18. Base Phone Antennae
19. Cord
20. Display
21. Telecommunications Tower
22. Wireless Service Provider Transmit and Receive Antennae
200. Satellite (Auxiliary) Phones
24. Corded or Cordless phone docking base and or receive/transmit base
25. Corded or Cordless Satellite (auxiliary) phone handset antenna
26. Cordless Satellite (auxiliary) phone handset
32. Building or structure
38. Wireless personal phone
39. adaptor

1. Apparatus comprising a wireless base phone configured to receive or transmit a wireless phone transmission from a wireless service provider, and at least one satellite (auxiliary) phone, the wireless base phone configured to retransmit the phone transmission to or from the satellite (auxiliary) phone.

2. Apparatus as set forth in claim 1, wherein the base phone comprises a phone base and a handset configured to be supported by the phone base, at least one of the phone base and handset configured to transmit a phone transmission to or from the auxiliary phone.

3. Apparatus as set forth in claim 1, wherein the (satellite) auxiliary phone comprises an auxiliary phone base and an auxiliary handset configured to be supported by the auxiliary phone base, at least one of the auxiliary phone base or auxiliary handset configured to be in circuit communication with the base phone.

4. Apparatus as set forth in claim 3, wherein the wireless base phone is in circuit communication with the satellite (auxiliary) phone base.

5. Apparatus as set forth in claim 2, wherein the phone base is in circuit communication with the auxiliary phone.

6. Apparatus as set forth in claim 1, wherein the wireless base phone and satellite (auxiliary) phone have respective antenna configured to provide cordless circuit communication between the wireless base phone and satellite (auxiliary) phone.

7. Apparatus as set forth in claim 1, wherein the base phone is configured to receive and/or transmit transmissions in four frequencies.

8. Apparatus as set forth in claim 7, wherein the base phone is configured to receive transmissions from a service provider and from an auxiliary phone in two of the four frequencies and to transmit transmissions to a service provider and to an auxiliary phone in two other of the four frequencies.
